(19) United States
(12) Patent Application Publication
(10) Pub. No.: US 2020/0334801 A1
(43) Pub. Date: Oct. 22, 2020

(54) LEARNING DEVICE, INSPECTION SYSTEM, LEARNING METHOD, INSPECTION METHOD, AND PROGRAM

(71) Applicant: NEC Corporation, Tokyo (JP)

(72) Inventors: Katsuhiko TAKAHASHI, Tokyo (JP); Takashi SHIBATA, Tokyo (JP)

(73) Assignee: NEC Corporation, Tokyo (JP)

(21) Appl. No.: 16/769,784

(22) PCT Filed: Dec. 6, 2017
(86) PCT No.: PCT/JP2017/043735

§ 371 Date: Jun. 4, 2020

(51) Int. Cl. G06T 7/00

(52) U.S. Cl. CPC G06T 7/001; G06T 2207/20081

(57) ABSTRACT

In the present invention, a first image acquisition means 81 acquires a first image of an inspection target including an abnormal part. A second image acquisition means 82 acquires a second image of the inspection target captured earlier than the time when the first image is captured. A learning data generation means 83 generates learning data indicating that the second image includes an abnormal part. A learning means 84 learns a discrimination dictionary by using the learning data generated by the learning data generation means 83.

### TECHNICAL FIELD

The present invention relates to a learning device, a learning method, and a learning program for learning a condition of an inspection target, and further to an inspection system, an inspection method, and an inspection program for performing inspection on the basis of learning results.

### BACKGROUND ART

There has been proposed a technique for inspecting degradation of objects, diseases that occur in a human body, and the like by machine learning. For example, Patent Literature (PTL) 1 discloses a device that learns a large amount of pre-labeled degraded image data and non-degraded image data to construct a dictionary for identification and that supports inspection of concrete structures.

PTL 2 discloses an image processing method of using case data relating to a change with time of a disease case, aligning the current image to a past image with respect to a lesion site of the same patient, and generating a difference image therebetween.

### CITATION LIST

### Patent Literature

PTL 1: Japanese Patent Application Laid-Open No. 2016-65809
PTL 2: Japanese Patent Application Laid-Open No. 2005-270635

### SUMMARY OF INVENTION

### Technical Problem

It is required that the degradation of objects, diseases that occur in a human body, and the like can be detected in an early stage. Therefore, it is preferable that the presence or absence of an abnormal condition can be inspected even from an image in which the abnormal condition does not appear remarkably.

In general, if it is possible to confirm that an abnormal condition remarkably appears on the surface from a captured image of an inspection target, such as a captured image of a large crack or a clearly captured image of a lesion, the image is able to be used as learning data including an abnormal part. For example, in the device described in PTL 1, a dictionary is constructed by learning image data that can be determined to be degraded as degraded image data and data that cannot be determined to be degraded as non-degraded image data.

In order to increase the accuracy of identifying an abnormal condition, preferably a large amount of learning data is available. If, however, an abnormal condition does not appear remarkably, such as in the case where the abnormal part is small in an initial stage of abnormality or the abnormal part is hidden by other structural features, it requires a lot of experience to determine the condition to be abnormal. In other words, it is difficult to detect an abnormality from such an image without a highly experienced high-level diagnoser, and therefore it is also difficult to acquire learning data as a result.

As described above, there is only a small amount of learning data indicating the inclusion of an abnormal condition that can be acquired from an image in which the abnormal condition does not appear remarkably, which leads to a problem that it is difficult to learn a dictionary for identifying an abnormal condition in the above situation.

Therefore, it is an object of the present invention to provide a learning device, a learning method, and a learning program capable of increasing the accuracy of determining whether or not an inspection target is abnormal, even in the case of a small amount of learning data indicating that the inspection target is abnormal, and an inspection system, an inspection method, and an inspection program for performing inspection on the basis of learning results.

### Solution to Problem

According to an aspect of the present invention, there is provided a learning device including: a first image acquisition means for acquiring a first image of an inspection target including an abnormal part; a second image acquisition means for acquiring a second image of the inspection target captured earlier than the time when the first image is captured; a learning data generation means for generating leaning data indicating that the second image includes an abnormal part; and a learning means for learning a discrimination dictionary by using the learning data generated by the learning data generation means.

According to another aspect of the present invention, there is provided an inspection system including: an image acquisition means for acquiring an image of an inspection target: an inspection means for inspecting the presence or absence of an abnormality in the inspection target from the acquired image by using a discrimination dictionary for discriminating the presence or absence of the abnormality in the inspection target, which has been learned by using learning data indicating that an abnormal part is included in a second image of the inspection target captured earlier than the time when a first image of the inspection target including an abnormal part is captured; and an output means for outputting a result of the inspection by the inspection means.

According to still another aspect of the present invention, there is provided a learning method including the steps of: acquiring a first image of an inspection target including an abnormal part; acquiring a second image of the inspection target captured earlier than the time when the first image is captured; generating learning data indicating that the second image includes an abnormal part; and learning a discrimination dictionary by using the generated learning data.

According to yet another aspect of the present invention, there is provided an inspection method including the steps of: acquiring an image of an inspection target; inspecting the presence or absence of an abnormality in the inspection target from the acquired image by using a discrimination dictionary for discriminating the presence or absence of the abnormality in the inspection target, which has been learned by using learning data indicating that an abnormal part is included in a second image of the inspection target captured earlier than the time when a first image of the inspection target including an abnormal part is captured; and outputting a result of the inspection.

According to still another aspect of the present invention, there is provided a learning program for causing a computer to perform: a first image acquisition process of acquiring a first image of an inspection target including an abnormal part; a second image acquisition process of acquiring a second image of the inspection target captured earlier than the time when the first image is captured; a learning data generation process of generating learning data indicating that the second image includes an abnormal part; and a learning process of learning a discrimination dictionary by using the learning data generated by the learning data generation process.

According to still another aspect of the present invention, there is provided an inspection program for causing a computer to perform: an image acquisition process of acquiring an image of an inspection target; an inspection process of inspecting the presence or absence of an abnormality in the inspection target from the acquired image by using a discrimination dictionary for discriminating the presence or absence of the abnormality in the inspection target, which has been learned by using learning data indicating that an abnormal part is included in a second image of the inspection target captured earlier than the time when a first image of the inspection target including an abnormal part is captured; and an output process of outputting a result of the inspection by the inspection means.

### Advantageous Effects of Invention

The present invention enables increase in the accuracy of determining whether or not an inspection target is abnormal even in the case where there is only a small amount of learning data indicating that the inspection target is abnormal.

### BRIEF DESCRIPTION OF DRAWINGS

FIG. 1 is a block diagram illustrating a configuration example of an embodiment of an inspection system of the present invention.

FIG. 2 is an explanatory diagram illustrating an example of image data.

FIG. 3 is an explanatory diagram illustrating a relationship between the deterioration level of an inspection target and the availability of learning data.

FIG. 4 is an explanatory diagram illustrating a relationship between the deterioration level of an inspection target and the availability of learning data.

FIG. 5 is an explanatory diagram illustrating an example of correct answer label data.

FIG. 6 is an explanatory diagram illustrating an example of image data obtained by observing the same inspection target at discrete times.

FIG. 7 is an explanatory diagram illustrating an example of a process of calculating pixel correspondence data.

FIG. 8 is an explanatory diagram illustrating an example of a correct answer label.

FIG. 9 is an explanatory diagram illustrating an example of a correct answer label.

FIG. 10 is an explanatory diagram illustrating an example of a relationship between the inspection target and the correct answer label.

FIG. 11 is a flowchart illustrating an operation example of a learning device.

FIG. 12 is a flowchart illustrating an operation example of the inspection system.

FIG. 13 is a block diagram illustrating an outline of the learning device according to the present invention.

FIG. 14 is a block diagram illustrating an outline of the inspection system according to the present invention.

FIG. 15 is a schematic block diagram illustrating a configuration of a computer according to at least one embodiment.

### DESCRIPTION OF EMBODIMENT

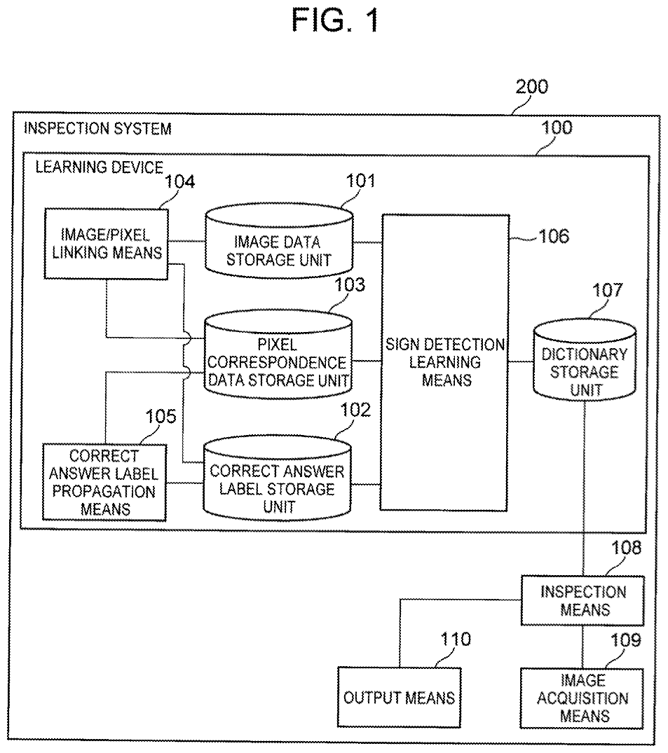

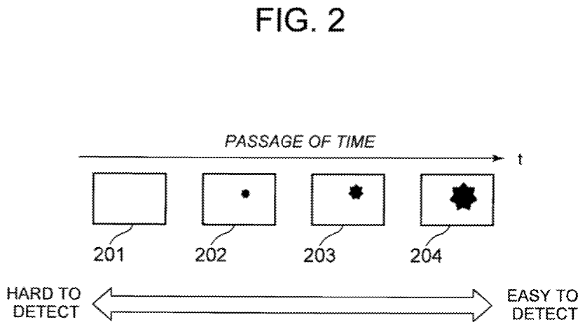

Hereinafter, preferred embodiments of the present invention will be described with reference to appended drawings. FIG. 1 is a block diagram illustrating a configuration example of an embodiment of an inspection system of the present invention. Moreover, FIG. 2 is an explanatory diagram illustrating an example of image data used in the present invention.

First, an inspection target assumed in the present invention will be described with reference to FIG. 2. In the present invention, the inspection target is assumed to have an abnormal condition that progresses over time (that is, the condition deteriorates), where the abnormal condition means a condition in which something that is not present in the normal condition exists or a condition that is not assumed in the normal condition.

In an example of a disease, a condition in which there is a lesion that is not present in the normal condition can be said to be an abnormal condition. Specifically, the abnormality in the inspection target includes a lesion, a tumor, an ulcer, an obstruction, or bleeding that has occurred in the inspection target or a sign of a disease that has occurred in the target to be inspected. In addition, in an example of object degradation, a condition in which there is a break (crack) on a wall, peeling of a wall, or discoloration of a wall can be said to be an abnormal condition.

In an example illustrated in FIG. 2, an abnormal condition of the inspection target progresses over time in the order of an image 201, an image 202, an image 203, and an image 204. Specifically, in the example illustrated in FIG. 2, the condition illustrated in the image 201 represents a normal condition, and the condition illustrated in the image 204 represents a condition in which an abnormality appears remarkably and easily determined (an abnormal condition).

An image in which an abnormality appears remarkably, such as the image 204, can be easily determined to indicate that the condition is abnormal, and therefore it is possible to collect a relatively large number of such images as learning data indicating abnormal conditions. An image, however, in which an abnormality does not appear remarkably, such as the image 203 or 202, frequently cannot be determined to indicate that the condition is abnormal at that time, and therefore such images frequently cannot be acquired as learning data indicating the abnormal condition.

If it is possible to use an image, in which an abnormality does not appear remarkably, such as the image 202 or 203, as learning data, abnormal conditions are able to be detected early. In this embodiment, focusing on the fact that the abnormal condition of the inspection target progresses over time, images captured in the past, with respect to the inspection target in which an abnormal condition is detected, are used as learning data indicating abnormal conditions.

In the example illustrated in FIG. 2, if the image 204 is determined to be an image that represents an abnormal condition, the past images 203 and 202 (if necessary, the image 201) captured with respect to the same inspection target are used as learning data indicating abnormal conditions.

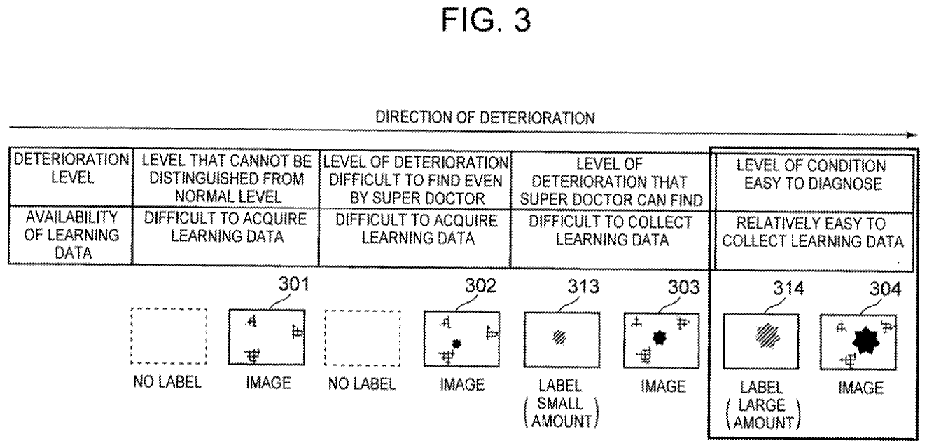

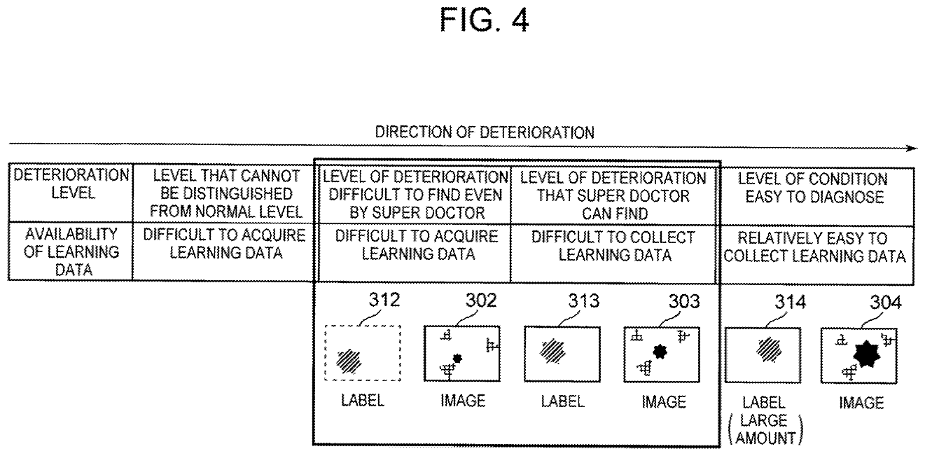

FIGS. 3 and 4 are explanatory diagrams illustrating a relationship between the deterioration level of an inspection target and the availability of learning data. FIGS. 3 and 4 illustrate the availability of degraded image data for learning (data indicating an abnormal condition) for each stage in the case where the progression is divided into four stages for events of the type in which the degradation or medical condition monotonously deteriorates.

The most readily available degraded image data for learning is an image 304 in which an advanced degradation or medical condition is captured and that can be diagnosed even by a normal-level diagnoser. It is because there are more normal-level diagnosers than high-level diagnosers and therefore image data in which an advanced degradation or medical condition is captured may be collected with a label 314 added by a large number of diagnosers.

The next most readily available data is an image 303 in which an advanced degradation or medical condition is captured and that can be diagnosed by a high-level diagnoser. Only high-level diagnosers, who are fewer than normal-level diagnosers, are able to add a label 313.

The most difficult data to obtain is an image 302, in which a degradation or medical condition in a state that is overlooked even by a high-level diagnoser is captured. It is because even a high-level diagnoser cannot distinguish the degradation or medical condition and therefore the image data is not labeled as image data indicating that a degradation or disease has started so as to be treated as data indicating a normal condition. Incidentally, an image 301 is data indicating a normal condition and no label is added to the image 301.

Therefore, in general machine learning, which is used to learn and diagnose an image in which a degradation or disease condition is captured, only an inspection device, with which normal-level diagnosers are able to make diagnoses, is constructed.

On the other hand, in the present embodiment, a lot of labeled data (label 313, label 312) is generated also from images in the stages indicated by the image 303 and the image 302 in FIG. 4. This enables construction of an inspection device with which high-level diagnosers are able to make diagnoses.

Referring to FIG. 1, an inspection system 200 of the present embodiment includes a learning device 100, an inspection means 108, an image acquisition means 109, and an output means 110.

In addition, the learning device 100 includes an image data storage unit 101, a correct answer label storage unit 102, a pixel correspondence data storage unit 103, an image/pixel linking means 104, a correct answer label propagation means 105, and a sign detection learning means 106, and a dictionary storage unit 107.

The image data storage unit 101 stores image data in which the same inspection target is captured over time. The image data storage unit 101 stores, for example, the images 301 to 304 as illustrated in FIG. 2. The image data storage unit 101 may store image data observed at discrete times or may store image data captured in time series. Incidentally, image data observed at discrete times means image data, which is not captured at consecutive times like a video image, but captured at non-consecutive times, dates, ages, or the like. In the following description, a series of image data in which the same inspection target has been captured over time is referred to as “image data group.”

An imaging device (not illustrated) that captures the same inspection target may be a fixed device or a moving device. Image data captured by a moving device is not always obtained by capturing the inspection target in the same position. Therefore, the image/pixel linking means 104 described later associates image data with each other. In the case of image data different in the position in which the inspection target is captured, the pixels at the same x, y coordinates in the two pieces of image data do not correspond to each other, but as a result, pixels in different x, y coordinates correspond to each other.

The correct answer label storage unit 102 stores a correct answer label added to the image data. The correct answer label is a label added to the image data stored in the image data storage unit 101 and is also label data indicating whether the inspection target is in a normal condition or in an abnormal condition (hereinafter, the label data is also referred to as “correct answer label data” in some cases).

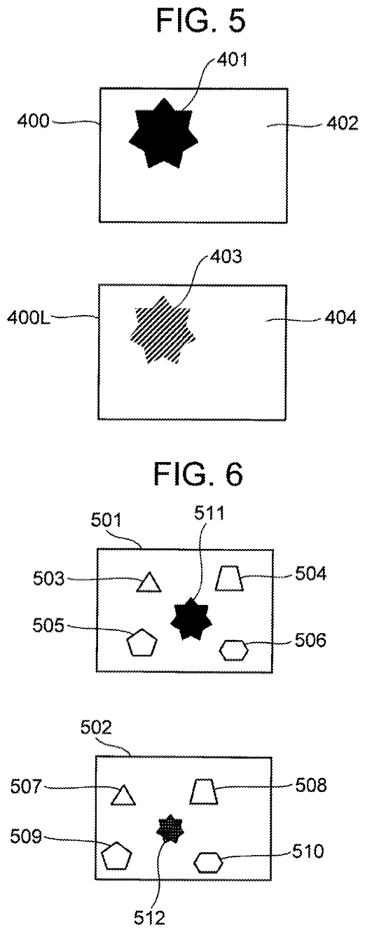

FIG. 5 is an explanatory diagram illustrating an example of correct answer label data. For example, it is supposed that an image 400 illustrated in FIG. 5 includes a pixel 401 appearing as degradation or a disease and a pixel 402 corresponding to a normal condition. In this situation, as correct answer label data 400L, a label 403 indicating degradation or a medical condition is added to the pixel 401, and a label 404 indicating a normality is added to the pixel 402.

FIG. 5 illustrates an example of how to add correct answer label data in pixel units. The units in which the correct answer label data is added, however, are not limited to the pixel units. For example, simply, a label indicating degradation or a medical condition may be added to a region represented by the four corner coordinates of a circumscribed rectangle that contains the pixel 401 appearing as degradation or a disease.

The correct answer label may be added to an abnormal part included in an image indicating an abnormal condition, which has been specified by a user, or may be added to an abnormal part of an image determined to be in an abnormal condition by the inspection means 108 described later.

As described above, in the initial state, a correct answer label is added to an image in which an abnormality appears remarkably. In other words, initially, a correct answer label is added only to image data captured at a relatively late time among image data. In addition, it is assumed that the correct answer label propagation means 105 and the sign detection learning means 106, which will be described later, add a correct answer label to image data captured at an earlier time.

The pixel correspondence data storage unit 103 stores data indicating a correspondence in pixels between image data (hereinafter, referred to as “pixel correspondence data”) observed at discrete times for the same inspection target. Specifically, the pixel correspondence data indicates a point-to-point correspondence between two images. The pixel correspondence data may be represented in, for example, a two-image format with pixel values assigned to the positional displacement amounts in the vertical and horizontal directions for each pixel between two images. Moreover, the pixel correspondence data may be represented by a circumscribed rectangle that contains the pixel 401 appearing as degradation or a disease and four corner coordinates of a rectangle corresponding to the circumscribed rectangle in the other image.

The image/pixel linking means 104 associates the image data observed at discrete times with each other for the same inspection target. Specifically, the image/pixel linking means 104 associates two pieces of image data with each other by specifying pixels in the relatively early image data that correspond to the pixels in the relatively late image data of the two pieces of image data. In other words, the image/pixel linking means 104 has a function of aligning the positions of the two images observed at discrete times, and therefore it can be said as a positioning means.

The image/pixel linking means 104, for example, may match both pieces of image data in which the same inspection target is captured against each other to associate the image data with each other at an image level and at a pixel level by using the correspondence between parts that do not change with time as a clue. Then, the image/pixel linking means 104 may store the pixel correspondence data that represents a result of the association into the pixel correspondence data storage unit 103.

FIG. 6 is an explanatory diagram illustrating an example of image data obtained by observing the same inspection target at discrete times. An image 501 illustrated in FIG. 6 represents an image captured at a certain time, and an image 502 represents an image captured earlier than the time when the image 501 is captured with respect to the same inspection target. In other words, the image 501 is an image captured at a later time than the image 502.

In addition, objects 503 to 506 captured in the image 501 and objects 507 to 510 captured in the image 502 represent objects that do not change with time, and objects 511 and 512 represent objects that change with time. In this respect, it is assumed that the objects 503 and 507, the objects 504 and 508, the objects 505 and 509, and the objects 506 and 510 are the same corresponding objects, respectively, and that the object 512 represents the previous condition of the object 511.

In the example illustrated in FIG. 6, a camera that captures the images is not fixed with respect to the inspection target. Therefore, the positions of the corresponding objects in the image 501 and in the image 502 are shifted mainly in the horizontal direction. Moreover, the object 511 in the image 501 and the object 512 in the image 502 are different in size and appearance.

In such a situation, the image/pixel linking means 104 associates points (pixels) in both images with each other, where the points correspond to points in the real world. The image/pixel linking means 104 may associate the pixels with each other by assuming a linear or non-linear transformation model for the most reasonable pixel-to-pixel correspondence between the objects 503 to 510 and between the objects 511 and 512, for example. Then, the image/pixel linking means 104 extracts a set of coordinates of the associated points and stores the set of coordinates as pixel correspondence data into the pixel correspondence data storage unit 103.

In the example illustrated in FIG. 6, it is considered to be error-free and more reasonable to associate the objects 503 to 506, which do not change with time, with the objects 507 to 510 only by parallel translation. Therefore, the image/pixel linking means 104 finds the pixel correspondence on the basis of such image transformation rules and stores information indicating the correspondence into the pixel correspondence data storage unit 103. For example, if a target object is a planar rigid body, the image transformation rules are able to be represented by a homography matrix. In addition, if the target object only moves in parallel, the image transformation rules can be represented by an affine transformation matrix.

Since the object 511 has changed with time, it is difficult to determine the corresponding points on the basis of the visual similarity. Therefore, the image/pixel linking means 104 may determine points calculated based on the same image transformation rules as for the object that does not degrade over time as the corresponding points. In other words, in the example illustrated in FIG. 6, a region having the same size as the object 511, which is one size larger than the object 512, may be set as a region corresponding to the object 511.

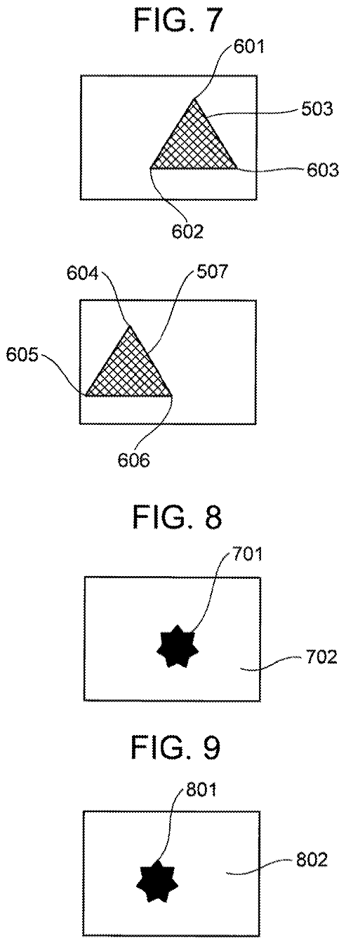

Subsequently, an example of pixel correspondence data calculated by the image/pixel linking means 104 will be described. FIG. 7 is an explanatory diagram illustrating an example of a process of calculating the pixel correspondence data. FIG. 7 illustrates an enlarged view of only the periphery of the object 503 in the image 501 and of the periphery of the object 507 in the image 502 illustrated in FIG. 6.

The object 503 includes three vertices 601, 602, and 603, and the object 507 includes three vertices 604, 605, and 606. Moreover, the vertex 601 and the vertex 604, the vertex 602 and the vertex 605, and the vertex 603 and the vertex 606 correspond to each other, respectively. The x, y coordinates of the vertices 601 to 606 are assumed to be (x₆₀₁, y₆₀₁), (x₆₀₂, y₆₀₂), (x₆₀₃, y₆₀₃), (x₆₀₄, y₆₀₄), (x₆₀₅, y₆₀₅), and (x₆₀₆, y₆₀₆), respectively.

In the above, an image that stores the x coordinate of a corresponding point from the image 501 to the image 502 is represented as Iₓ (xₙ, yₙ), and an image that stores the y coordinate of the corresponding point from the image 501 to the image 502 is represented as I_{y} (xₙ, yₙ). In this case, the respective images Iₓ and I_{y} store the following values:

Iₓ(x₆₀₁,y₆₀₁)=x₆₀₄

Iₓ(x₆₀₂,y₆₀₂)=x₆₀₅

Iₓ(x₆₀₃,y₆₀₃)=x₆₀₆

I_{y}(x₆₀₁,y₆₀₁)=y₆₀₄

I_{y}(x₆₀₂,y₆₀₂)=y₆₀₅

I_{y}(x₆₀₃,y₆₀₃)=y₆₀₆

The image/pixel linking means 104 may store the images Iₓ and I_{y} as pixel correspondence data in the pixel correspondence data storage unit 103.

Moreover, the image/pixel linking means 104 may store information, in which the x and y coordinates of the corresponding points are arranged as follows, as pixel correspondence data, in the pixel correspondence data storage unit 103:

x₆₀₁, y₆₀₁, x₆₀₄, y₆₀₄
x₆₀₂, y₆₀₂, x₆₀₅, y₆₀₅
x₆₀₃, y₆₀₃, x₆₀₆, y₆₀₆

In the above description, only the information including the vertices of the target objects associated with each other has been described to simplify the description, but the information for association is not limited to the vertices of the target object. The image/pixel linking means 104 may associate, for example, information indicating the contours of the target object with each other or may associate characteristic points inside the target object with each other.

With respect to two pieces of image data included in the image data group, the correct answer label propagation means 105 uses the correct answer label added to image data captured at a relatively late time to generate a new correct answer label for a relatively early image data on the basis of the pixel correspondence data. Thus, data in which the correct answer label is added to the image data can be used as learning data. Therefore, adding a correct answer label to image data can be said to be generating learning data.

For example, in the case where the pixel correspondence data is associated with each other in pixel units, the correct answer label propagation means 105 may generate learning data in which a label indicating an abnormality is added to a pixel corresponding to an abnormal part. Moreover, in the case where the pixel correspondence data is associated with each other by using a circumscribed rectangle that contains an abnormal part, the correct answer label propagation means 105 may generate learning data in which a label indicating an abnormality is added to a region including a pixel corresponding to the abnormal part.

Specifically, first, the correct answer label propagation means 105 acquires an image including the abnormal part of the inspection target (hereinafter, referred to as “first image”) from the image data storage unit 101. Subsequently, the correct answer label propagation means 105 acquires an image of the inspection target captured earlier than the time when the first image is captured (hereinafter, referred to as “second image”). Then, the correct answer label propagation means 105 generates learning data indicating that the acquired second image includes the abnormal part by propagating the correct answer label of the first image to the second image. In this respect, propagating the correct answer label means generating learning data indicating that an abnormality is present in the region of the second image corresponding to the abnormal part in the first image.

The following describes a method of propagating the correct answer label.

FIGS. 8 and 9 are explanatory diagrams illustrating examples of a correct answer label. The correct answer label illustrated in FIG. 8 indicates the correct answer label added to the image 501 (the first image) captured at a relatively late time. Specifically, a region 701 of the image 501 illustrated in FIG. 8 has a label, added thereto, indicating that the region is abnormal, and the region 702 has a label, added thereto, indicating that the region is normal. This label may be added as, for example, a pixel value in the diagram.

In the example illustrated in FIG. 7, the object 507 is captured more to the left than the object 503. Therefore, in the case where the pixel correspondence data in this case is used for the image data 502 (the second image) captured at a time earlier than the image 501, the correct answer label propagation means 105 generates, for example, a label image illustrated in FIG. 9. Specifically, the correct answer label propagation means 105 generates a correct answer label with a label indicating an abnormal region added to a region 801 and with a label indicating a normal region added to a region 802. Thus, the correct answer label originally has not been added to the image data 502, but the correct answer label propagation means 105 adds the correct answer label to the image data 502.

Moreover, if the correct answer label originally has been added to the image data 502, the correct answer label propagation means 105 may replace the original correct answer label with a new correct answer label to be propagated or may give a user a notice to prompt the user for selecting either one of the correct answer labels.

Moreover, the correct answer label propagation means 105 may avoid the selection of the image data to which a correct answer label has already been added for relatively early data when selecting image data from an image data group.

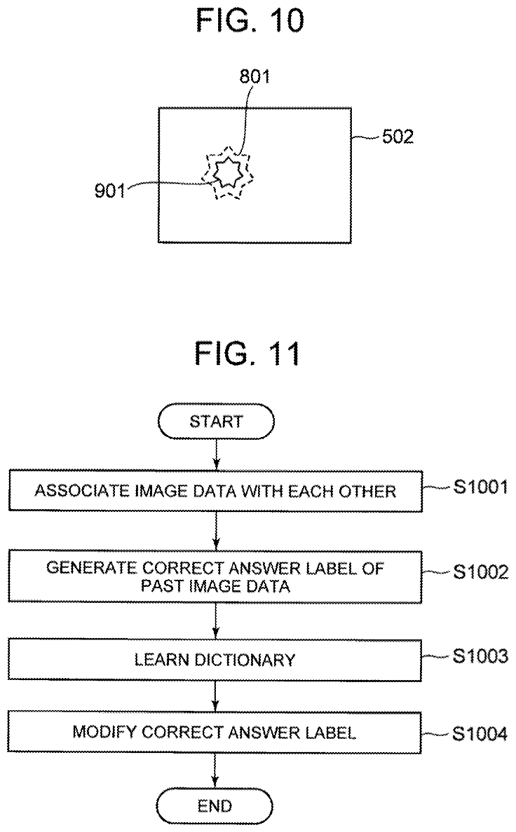

A relationship between the correct answer label image added to the image data 502 and the image data 502 will now be described. FIG. 10 is an explanatory diagram illustrating an example of a relationship between the inspection target and the correct answer label. The region 801 illustrated in FIG. 10 is a region having the same size as the correct answer label added to the image 501.

A region corresponding to degradation or a medical condition (in other words, a region to be inspected) is generally considered to expand from moment to moment. In that case, a region corresponding to degradation or a medical condition in the image data 502 is considered to be smaller than the region in the image 501. In the image data 502, if a region 901 corresponds to degradation or a medical condition, the region 801 is assumed to be one size larger than the region 901. In other words, since the region 801 contains the region 901 corresponding to the degradation or medical condition in the image data 502, it can be said that there is no problem as learning data. Therefore, the correct answer label propagation means 105 may add the correct answer label of the region having the same size as the correct answer label added to the first image to the second image.

If the enlargement ratio of the region corresponding to degradation or a medical condition with respect to the passage of time is known, the correct answer label propagation means 105 may generate a correct answer label obtained by reducing the size of the region 801 according to the ratio on the basis of the enlargement ratio. Conversely, if the region corresponding to the degradation or medical condition is likely to shrink over time, the correct answer label propagation means 105 may generate a correct answer label in which the size of the region 801 is expanded on the basis of the shrinking ratio. In other words, the correct answer label propagation means 105 may add the correct answer label of a region obtained by transforming the correct answer label added to the first image at a predetermined ratio to the second image.

Note that, if the image data to which the correct answer label is propagated is the image 301 at “a level that cannot be distinguished from a normal level” as illustrated in FIG. 3, the image data is actually considered to include no region corresponding to degradation or a medical condition. Therefore, in the present embodiment, first, the correct answer label propagation means 105 may generate a correct answer label, and the sign detection learning means 106 described later may perform processing on the learning data to which the correct answer label is added.

Moreover, if the image data group includes image data still earlier than the past image data to which the correct answer label is propagated, the correct answer label propagation means 105 may propagate the correct answer label added to the past image data to the still earlier image data. The range over which the correct answer label propagation means 105 recursively propagates the correct answer label is arbitrary. For example, the correct answer label may be retroactively propagated to past image data a predetermined number of times earlier, or the correct answer label may be propagated to all image data included in the image data group.

Going further back in time, the more the correct answer label is likely to be inconsistent, in other words, the more it is likely to add a label indicating an abnormality to image data that is actually not abnormal. Therefore, the correct answer label propagation means 105 may limit the range in which the correct answer label is propagated recursively, taking into account an error probability obtained when the correct answer label is propagated. In addition, the sign detection learning means 106 described later may perform learning for which the error probability is considered. The error probability will be described later.

As described above, the correct answer label propagation means 105 creates learning data indicating that an abnormal part is included from the second image that is uncertain whether or not it includes an abnormal part on the basis of the first image of an inspection target including an abnormal part. Therefore, learning data can be increased and thus, even if there is only a small amount of learning data indicating an abnormality of the inspection target, it is possible to increase the discrimination accuracy of the dictionary for determining whether or not the inspection target is abnormal.

The sign detection learning means 106 learns the discrimination dictionary by using learning data generated by the correct answer label propagation means 105, in other words, image data with a correct answer label added thereto. Specifically, the sign detection learning means 106 learns the discrimination dictionary by performing supervised machine learning to identify whether or not the region corresponds to degradation or a medical condition by using an image data group, a correct answer label previously added to the image data group, and a correct answer label added by the correct answer label propagation means 105.

The algorithm used by the sign detection learning means 106 for machine learning is arbitrary. The sign detection learning means 106 may use a method of optimizing feature extraction and identification at the same time, such as, for example, a deep convolutional neural network. In addition, the sign detection learning means 106 may learn the discrimination dictionary with a combination of the histogram-of-gradient feature extraction and the support-vector-machine learning device.

In this embodiment, the correct answer label is propagated to past image data to generate learning data. Therefore, in comparison with the learning data used in general machine learning, there may be an error included in the added correct answer label. For example, there could be a case where degradation or a disease has not yet started in the region 801 to which the correct answer label propagation means 105 has added a label corresponding to degradation or a medical condition and therefore the region is actually data corresponding to a normal condition.

Therefore, the sign detection learning means 106 performs learning by assigning a weight to the learning data in consideration of the certainty of the learning data. The weight is set higher for the learning data to which the correct answer label is originally added, and the weight is set lower for the earlier image data to which the correct answer label propagation means 105 propagates the correct answer label (going further back in time when the image is acquired). Furthermore, it is preferable that this weight is set lower as the rate of change in the degradation or medical condition of the inspection target is higher.

The longer the time goes back and the higher the rate of change in degradation or a medical condition is, it is more likely that the correct answer label added by the correct answer label propagation means 105 is erroneous. Therefore, the sign detection learning means 106 sets the weight relatively lower for such learning data. In this manner, setting the weight lower for the learning data prone to an error in adding a correct answer label enables a reduction in influences of these pieces of learning data exerted on parameter (dictionary) estimation during learning. Therefore, the adverse effects during learning can be suppressed.

The sign detection learning means 106 may calculate, for example, an error for which the weight on data is taken into account. Specifically, when calculating an error between an output value of an output layer and teacher data (cross entropy) in learning a deep convolutional neural network, the error for the data is multiplied by the weight for the data to calculate the sum for each data, thereby enabling a calculation of an error for which the weight on the data is taken into account.

On the other hand, the sign detection learning means 106 may increase the weight on learning data in which the correct answer label added by the correct answer label propagation means 105 is more correct so as to contribute to the parameter (dictionary) estimation. For example, in the case where a correct answer label is propagated to an image captured at the time one unit time earlier, the probability that the correct answer label is erroneous is assumed to be p (≤1). In this respect, the sign detection learning means 106 may set the weight for the image data that is t unit times earlier to (1−p)^{t}. The value of p can be previously determined according to an experience or the like.

As described above, the sign detection learning means 106 may change the weight on the data to which the correct answer label propagation means 105 has added a correct answer label so that the learning error is reduced. This enables learning data to which the correct answer label is added to contribute more to learning, and enables data to which an erroneous correct answer label is added to contribute less to learning.

In addition, the sign detection learning means 106 may modify the weight by using the stochastic gradient descent method or the like. In this case, the sign detection learning means 106 may reduce a learning coefficient so that the amount of weight modification decreases as the time further goes back and as the rate of change in the degradation or medical condition increases.

If, however, the weight is changed so that the learning error is reduced from the beginning of learning, it makes it difficult to progress the learning of the originally identifiable data. For this reason, preferably the sign detection learning means 106 does not change the weight at the beginning of learning, but changes the weight in the late stage of learning. In addition, the sign detection learning means 106 may limit the amount of weight change for data per epoch to a small value so that the data can be identified by dictionary learning as much as possible.

Furthermore, the sign detection learning means 106 may perform an identification experiment by using parameters given by the discrimination dictionary (network weights or a recognition dictionary) after the learning is completed. Then, the sign detection learning means 106 may estimate that the image data (pattern) that could not be correctly identified has an erroneous correct answer label. At this time, the sign detection learning means 106 may change the correct answer label to a label indicating a normality, and may cancel the correct answer label indicating degradation.

Specifically, in the case where the sign detection learning means 106 determines that learning data is normal as a result of inspecting the learning data by using the discrimination dictionary, the sign detection learning means 106 may change the certainty of the learning data to a lower level and may change the learning data to learning data indicating that there is no abnormality.

In this way, the sign detection learning means 106 learns a dictionary for use in detecting signs of degradation or a medical condition and reviews correct answer labels.

In the above description, there has been described the case where the sign detection learning means 106 sets the weight indicating the certainty of learning data. The correct answer label propagation means 105, however, may add the weight indicating the certainty of the learning data to the learning data as auxiliary data.

Specifically, the correct answer label propagation means 105 may add the auxiliary data indicating the certainty of the learning data to the image data to which the correct answer label is added (in other words, the learning data indicating that there is an abnormality). In this case, the sign detection learning means 106 can learn the discrimination dictionary by using the learning data including the added auxiliary data.

At that time, the correct answer label propagation means 105 may set the certainty of the learning data lower as the learning data is based on an image captured earlier, as indicated by the above probability p.

The correct answer label propagation means 105 may use the probability p that the correct answer label is erroneous to limit the range in which the correct answer label is propagated. Specifically, the correct answer label propagation means 105 may prevent the correct answer label from being propagated if the probability p falls below a predetermined threshold.

The dictionary storage unit 107 stores the discrimination dictionary learned by the sign detection learning means 106. For example, if the sign detection learning means 106 learns the discrimination dictionary by deep learning, the discrimination dictionary contains, for example, the weight of the network. If the sign detection learning means 106 learns the discrimination dictionary by a support vector machine (SVM), the discrimination dictionary includes a support vector and its weight.

The image acquisition means 109 acquires an image of an inspection target. The aspect of the image acquisition means 109 is arbitrary. The image acquisition means 109 may be implemented by an interface that acquires the image of the inspection target from another system or storage unit (not illustrated), for example, via a network.

In addition, the image acquisition means 109 may be implemented by a computer (not illustrated) connected to various devices that acquire images to acquire the images of the inspection target from the various devices. For example, in a situation in which a medical condition is inspected, the devices that acquire images may be an endoscope, an X-ray machine, a computed tomography (CT) machine, a magnetic resonance imaging (MRI) machine, a visible light camera, an infrared camera, and the like.

The inspection means 108 uses the learned discrimination dictionary (specifically, the discrimination dictionary stored in the dictionary storage unit 107) to inspect the presence or absence of an abnormality of the inspection target from acquired images. The acquired images may be processed by the inspection means 108 according to the dictionary used for the inspection.

The output means 110 outputs a result of the inspection. The output means 110 is implemented by, for example, a display device or the like.

The image/pixel linking means 104, the correct answer label propagation means 105, and the sign detection learning means 106 are implemented by a computer processor (for example, a central processing unit (CPU), a graphics processing unit (GPU), or a field-programmable gate array (FPGA)) that operates according to a program (a learning program).

For example, the program may be stored in the storage unit (not illustrated), so that the processor reads the program to operate as the image/pixel linking means 104, the correct answer label propagation means 105, and the sign detection learning means 106 according to the program. Moreover, the function of a monitoring system may be provided in a software-as-a-service (SaaS) format.

The image/pixel linking means 104, the correct answer label propagation means 105, and the sign detection learning means 106 each may be implemented by dedicated hardware. In addition, some or all of the components of each device may be implemented by a general-purpose or dedicated circuitry, a processor and the like, or a combination thereof. These may be composed of a single chip or multiple chips connected via a bus. These may be composed of a single chip or multiple chips connected via a bus. Some or all of the components of each device may be implemented by a combination of the above-described circuitry and the like and a program.

The inspection means 108 is also implemented by a computer processor that operates according to a program (an inspection program). Moreover, the control of the image acquisition means 109 and the output means 110 may be performed by the computer processor that operates according to the program (the inspection program).

In the case where some or all of the components of the inspection system are implemented by multiple information processing devices, circuitries, or the like, the multiple information processing devices or circuitries may be either centralized or distributed. For example, the information processing devices, circuitries, or the like may be implemented in the form of being connected to each other via a communication network such as a client server system, a cloud computing system, or the like.

The image data storage unit 101, the correct answer label storage unit 102, the pixel correspondence data storage unit 103, and the dictionary storage unit 107 are implemented by, for example, a magnetic disk device and the like.

Subsequently, the operation of the learning device according to this embodiment will be described. FIG. 11 is a flowchart illustrating an operation example of the learning device 100 of this embodiment.

The image/pixel linking means 104 matches time-series image data, which have been obtained by observing the same thing at discrete times, against each other among image data included in an image data group stored in the image data storage unit 101. Then, the image/pixel linking means 104 associates the matched image data with each other at an image level and at a pixel level and stores the pixel correspondence data indicating a result of the association in the pixel correspondence data storage unit 103 (step S1001).

Subsequently, the correct answer label propagation means 105 selects each pair of all image data included in the associated image data group. Then, the correct answer label propagation means 105 generates a correct answer label of relatively early image data from the correct answer label added to the image data captured at a relatively late time on the basis of the pixel correspondence data (step S1002).

The sign detection learning means 106 uses the image data corresponding to the new correct answer label added in step S1002 in addition to the image data included in the image data group to which the correct answer label has been added in advance to learn the discrimination dictionary for use in detecting signs of degradation and medical conditions (step S1003).

Thereafter, the sign detection learning means 106 inspects the correct answer label (learning data) by using the learned discrimination dictionary and modifies the correct answer label added in step S1002 (step S1004).

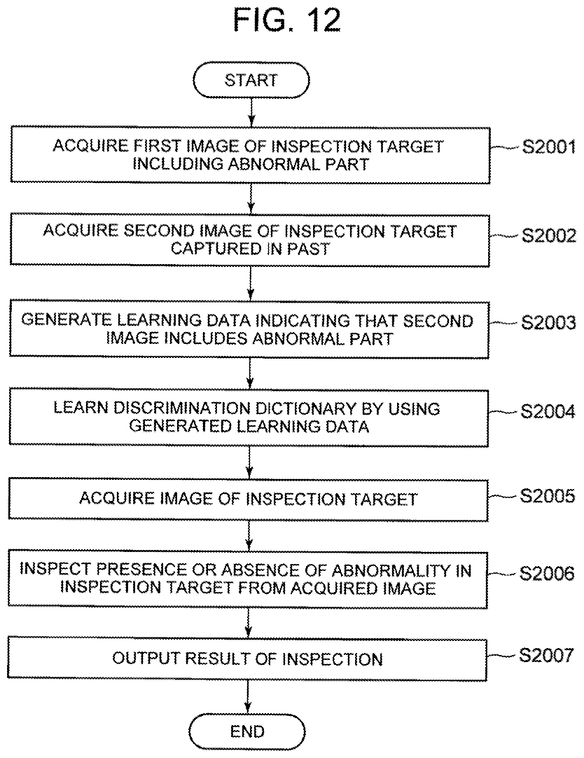

Subsequently, the operation of the inspection system according to this embodiment will be described. FIG. 12 is a flowchart illustrating an operation example of the inspection system according to this embodiment.

The correct answer label propagation means 105 acquires a first image of an inspection target including an abnormal part (step S2001). Moreover, the correct answer label propagation means 105 acquires a second image of the inspection target captured earlier than the time when the first image is captured (step S2002) and generates learning data indicating that the second image includes an abnormal part (Step S2003). Then, the sign detection learning means 106 learns the discrimination dictionary by using the generated learning data (step S2004).

On the other hand, if the image acquisition means 109 acquires the image of the inspection target (step S2005), the inspection means 108 inspects the presence or absence of an abnormality in the inspection target from the acquired image by using the discrimination dictionary (step S2006). Furthermore, the output means 110 outputs a result of the inspection (Step S2007)

As described above, in this embodiment, the correct answer label propagation means 105 acquires the first image of an inspection target including an abnormal part, and a second image of the inspection target captured earlier than the time when the first image is captured and generates learning data indicating that the second image includes an abnormal part. Furthermore, the sign detection learning means 106 learns the discrimination dictionary by using the generated learning data.

Therefore, even if there is only a small amount of learning data indicating an abnormality of the inspection target, it is possible to increase the accuracy of determining whether or not the inspection target is abnormal. This enables discovering degradation or a medical condition that can be diagnosed only by a high-level diagnoser and degradation or a medical condition in a state that is overlooked even by a high-level diagnoser.

This is because, in this embodiment, in the case where image data capturing degradation or a medical condition, which can be diagnosed by a normal-level diagnoser, is acquired, the image/pixel linking means 104 associates a region positionally corresponding to a portion indicating the degradation or medical condition with a region in image data capturing the same portion in the past at a pixel level or at a small region level. Specifically, the image/pixel linking means 104 associates the image data, at a pixel level, with an image data group capturing the same place or the same organ of the same person in the past.

Then, the correct answer label propagation means 105 generates learning data in which a label indicating degradation or a disease is added to pixels in the associated region in the past image. In other words, the correct answer label propagation means 105 adds a correct answer label to image data capturing degradation or a medical condition that can be diagnosed only by a high-level diagnoser and image data capturing degradation or a medical condition in a state that is overlooked even by a high-level diagnoser.

Therefore, the sign detection learning means 106 is able to learn the above-described image data to which the correct answer label is added as initial data of degradation or a medical condition, thereby enabling generation of a dictionary by which degradation or a medical condition in this state is identifiable.

In other words, in this embodiment, the correct answer label propagation means 105 adds correct answer label to image data capturing degradation or a medical condition that can be diagnosed only by a high-level diagnoser and image data capturing degradation or a medical condition in a state that is overlooked even by a high-level diagnoser, which generally have not been effectively used. This enables learning the degradation or a medical condition in the above state, for which leaning data has been insufficient, by using good-quality data.

Furthermore, in this embodiment, the sign detection learning means 106 sets the weight of data relatively lower, with respect to data to which a correct answer label is likely to be erroneously added. Therefore, adverse effects on machine learning can be suppressed.

Furthermore, in this embodiment, the image acquisition means 109 acquires the image of the inspection target, the inspection means 108 inspects the presence or absence of an abnormality of the inspection target from the acquired image by using the discrimination dictionary, and the output means 110 outputs a result of the inspection by the inspection means. This enables detection of deterioration of a target that can be inspected by a high-level diagnoser.

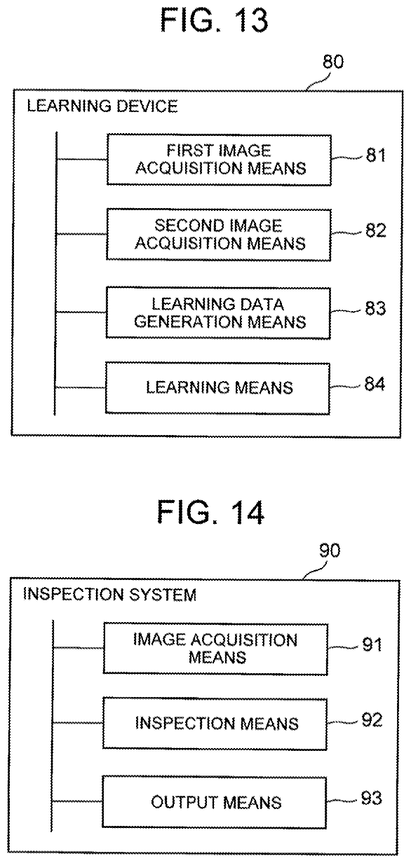

Subsequently, the outline of the present invention will be described. FIG. 13 is a block diagram illustrating an outline of a learning device according to the present invention. The learning device 80 (for example, the learning device 100) according to the present invention includes: a first image acquisition means 81 (for example, the correct answer label propagation means 105) for acquiring a first image of an inspection target including an abnormal part; a second image acquisition means 82 (for example, the correct answer label propagation means 105) for acquiring a second image of the inspection target captured earlier than the time when the first image is captured; a learning data generation means 83 (for example, the correct answer label propagation means 105) for generating learning data (for example, the correct answer label) indicating that the second image includes an abnormal part; and a learning means 84 (for example, the sign detection learning means 106) for learning a discrimination dictionary by using the learning data generated by the learning data generation means 83.

With the above configuration, even in the case where there is only a small amount of learning data indicating an abnormality in the inspection target, the accuracy of determining whether or not the inspection target is abnormal can be increased.

In addition, the configuration may include an inspection means (for example, the inspection means 108) for inspecting the inspection target by using the learned discrimination dictionary. The inspection with the discrimination dictionary described above makes it possible to detect a deteriorated condition that can be inspected by a high-level diagnoser.

Moreover, the abnormality in the inspection target may be one of a lesion, a tumor, an ulcer, an obstruction, or bleeding that has occurred in the inspection target and a sign of a disease that has occurred in a target to be inspected. In such cases, abnormalities can be detected from the initial symptoms of the disease.

In addition, the learning data generation means 83 may add auxiliary data indicating the certainty (for example, the weight) of the learning data to learning data indicating the presence of an abnormality. Furthermore, the learning means 84 may learn the discrimination dictionary by using the learning data including the auxiliary data. This configuration makes it possible to suppress the adverse effect on machine learning using learning data that has an error in whether or not there is an abnormality.

In the above configuration, the learning data generation means 83 may set the certainty (for example, the above probability p) of the learning data lower as the learning data is based on an image captured earlier.

In addition, in the case where the leaning data is inspected by using the discrimination dictionary and thereby it is determined that there is no abnormality in the leaning data, the learning means 84 may change the certainty of the learning data to a lower level. Similarly, in the case where the leaning data is inspected by using the discrimination dictionary and thereby it is determined that there is no abnormality in the leaning data, the learning means 84 may change the learning data to leaning data indicating that there is no abnormality. This configuration makes it possible to suppress the adverse effect on machine learning.

Moreover, the learning device 80 may include an alignment means (for example, the image/pixel linking means 104) for aligning the first image to the second image. Furthermore, the learning data generation means 83 may generate learning data indicating that there is an abnormality in the region of the second image corresponding to the abnormal part in the first image.

Specifically, the learning data generation means 83 may generate learning data in which a label indicating an abnormality is added to pixels corresponding to the abnormal part or learning data in which a label indicating an abnormality is added to a region including the pixels corresponding to the abnormal part.

Moreover, the learning data generation means 83 may generate learning data indicating that an abnormal part is included from the second image in which it is uncertain whether or not the abnormal part is included on the basis of the first image of the inspection target including the abnormal part. According to the above configuration, learning data can be generated from data that has not been used until then, thereby enabling an increase in the accuracy of learning a dictionary.

FIG. 14 is a block diagram illustrating an outline of an inspection system according to the present invention. An inspection system 90 (for example, the inspection system 200) according to the present invention includes: an image acquisition means 91 (for example, the image acquisition means 109) for acquiring an image of an inspection target; an inspection means 92 (for example, the inspection means 108) for inspecting the presence or absence of an abnormality in the inspection target from the acquired image by using a discrimination dictionary for discriminating the presence or absence of the abnormality in the inspection target, which has been learned by using learning data indicating that an abnormal part is included in a second image of the inspection target captured earlier than the time when a first image of the inspection target including an abnormal part is captured; and an output means 93 (for example, the output means 110) for outputting a result of the inspection by the inspection means 92.

The above configuration enables detection of deterioration of a target that can be inspected by a high-level diagnoser.

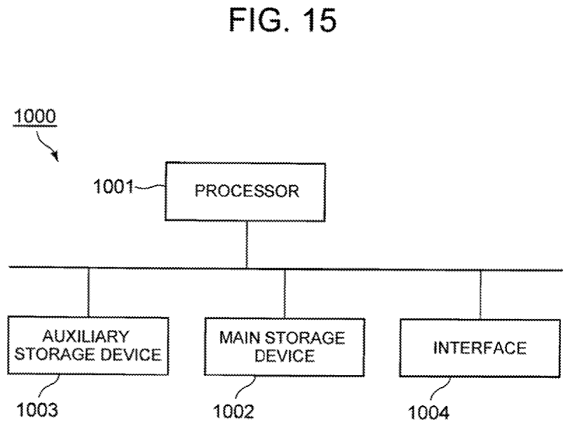

FIG. 15 is a schematic block diagram illustrating a configuration of a computer according to at least one embodiment. A computer 1000 includes a processor 1001, a main storage device 1002, an auxiliary storage device 1003, and an interface 1004.

The learning device described above is installed in the computer 1000. The operation of each processing unit described above is stored in the auxiliary storage device 1003 in the form of a program (learning program). The processor 1001 reads out the program from the auxiliary storage device 1003, develops the program to the main storage device 1002, and performs the above processing according to the program.

In at least one embodiment, the auxiliary storage device 1003 is an example of a non-transitory tangible medium. As other examples of the non-transitory tangible medium, there are cited a magnetic disk, a magnetic optical disk, a CD-ROM, a DVD-ROM, a semiconductor memory, or the like connected via the interface 1004. Moreover, in the case where the program is distributed to the computer 1000 via communication lines, the computer 1000 which has received the distributed program may develop the program to the main storage device 1002 and perform the above processing.

Furthermore, the program may be for use in implementing some of the above functions. Moreover, the program may be a so-called differential file (differential program) for implementing the above functions in combination with another program already stored in the auxiliary storage device 1003.

Some or all of the above embodiments may also be described as in the following Supplementary notes, but not limited thereto.

(Supplementary note 1) A learning device comprising: a first image acquisition means for acquiring a first image of an inspection target including an abnormal part; a second image acquisition means for acquiring a second image of the inspection target captured earlier than the time when the first image is captured; a learning data generation means for generating learning data indicating that the second image includes an abnormal part; and a learning means for learning a discrimination dictionary by using the learning data generated by the learning data generation means.

(Supplementary note 2) The learning device according to Supplementary note 1, further comprising an inspection means for inspecting the inspection target by using the learned discrimination dictionary.

(Supplementary note 3) The learning device according to Supplementary note 1 or 2, wherein the abnormality in the inspection target is one of a lesion, a tumor, an ulcer, an obstruction, or bleeding that has occurred in the inspection target and a sign of a disease that has occurred in a target to be inspected.

(Supplementary note 4) The learning device according to any one of Supplementary notes 1 to 3, wherein: the learning data generation means adds auxiliary data indicating the certainty of the learning data to learning data indicating the presence of an abnormality; and the learning means learns the discrimination dictionary by using the learning data including the auxiliary data.

(Supplementary note 5) The learning device according to Supplementary note 4, wherein the learning data generation means sets the certainty of the learning data lower as the learning data is based on an image captured earlier.

(Supplementary note 6) The learning device according to Supplementary note 4 or 5, wherein, in the case where the leaning data is inspected by using the discrimination dictionary and thereby it is determined that there is no abnormality in the leaning data, the learning means changes the certainty of the learning data to a lower level.

(Supplementary note 7) The learning device according to any one of Supplementary notes 1 to 3, wherein, in the case where the leaning data is inspected by using the discrimination dictionary and thereby it is determined that there is no abnormality in the leaning data, the learning means changes the learning data to leaning data indicating that there is no abnormality.

(Supplementary note 8) The learning device according to any one of Supplementary notes 1 to 7, further comprising an alignment means for aligning the first image to the second image, wherein the learning data generation means generates learning data indicating that there is an abnormality in a region of the second image corresponding to the abnormal part in the first image.

(Supplementary note 9) The learning device according to Supplementary note 8, wherein the learning data generation means generates learning data in which a label indicating an abnormality is added to pixels corresponding to the abnormal part or learning data in which a label indicating an abnormality is added to a region including the pixels corresponding to the abnormal part.

(Supplementary note 10) The learning device according to any one of Supplementary notes 1 to 9, wherein the learning data generation means generates learning data indicating that an abnormal part is included from the second image in which it is uncertain whether or not the abnormal part is included on the basis of the first image of the inspection target including the abnormal part.

(Supplementary note 11) An inspection system comprising: an image acquisition means for acquiring an image of an inspection target; an inspection means for inspecting the presence or absence of an abnormality in the inspection target from the acquired image by using a discrimination dictionary for discriminating the presence or absence of the abnormality in the inspection target, which has been learned by using learning data indicating that an abnormal part is included in a second image of the inspection target captured earlier than the time when a first image of the inspection target including an abnormal part is captured; and an output means for outputting a result of the inspection by the inspection means.

(Supplementary note 12) A learning method comprising the steps of: acquiring a first image of an inspection target including an abnormal part; acquiring a second image of the inspection target captured earlier than the time when the first image is captured; generating learning data indicating that the second image includes an abnormal part; and learning a discrimination dictionary by using the generated learning data.

(Supplementary note 13) An inspection method comprising the steps of: acquiring an image of an inspection target; inspecting the presence or absence of an abnormality in the inspection target from the acquired image by using a discrimination dictionary for discriminating the presence or absence of the abnormality in the inspection target, which has been learned by using learning data indicating that an abnormal part is included in a second image of the inspection target captured earlier than the time when a first image of the inspection target including an abnormal part is captured; and outputting a result of the inspection.

(Supplementary note 14) A learning program for causing a computer to perform: a first image acquisition process of acquiring a first image of an inspection target including an abnormal part; a second image acquisition process of acquiring a second image of the inspection target captured earlier than the time when the first image is captured; a learning data generation process of generating learning data indicating that the second image includes an abnormal part; and a learning process of learning a discrimination dictionary by using the learning data generated by the learning data generation process.

(Supplementary note 15) An inspection program for causing a computer to perform: an image acquisition process of acquiring an image of an inspection target; an inspection process of inspecting the presence or absence of an abnormality in the inspection target from the acquired image by using a discrimination dictionary for discriminating the presence or absence of the abnormality in the inspection target, which has been learned by using learning data indicating that an abnormal part is included in a second image of the inspection target captured earlier than the time when a first image of the inspection target including an abnormal part is captured; and an output process of outputting a result of the inspection by the inspection means.

### REFERENCE SIGNS LIST

100 Learning device
101 Image data storage unit
102 Correct answer label storage unit
103 Pixel correspondence data storage unit
104 Image/pixel linking means
105 Correct answer label propagation means
106 Sign detection learning means
107 Dictionary storage unit
108 Inspection means
109 Image acquisition means
110 Output means
200 Inspection system
201 to 204, 301 to 304, 400, 501, 502 Image
312 to 314 Label
401 to 404 Pixel
503 to 512 Object
601 to 606 Vertex
701, 702, 801, 802 Region

1. A learning device comprising a hardware processor configured to execute a software code to:
acquire a first image of an inspection target including an abnormal part;
acquire a second image of the inspection target captured earlier than the time when the first image is captured;
generate learning data indicating that the second image includes an abnormal part; and
learn a discrimination dictionary by using the learning data generated by the learning data generation means.

2. The learning device according to claim 1, comprising the hardware processor configured to execute a software code to inspect means for inspecting the inspection target by using the learned discrimination dictionary.

3. The learning device according to claim 1, wherein the abnormality in the inspection target is one of a lesion, a tumor, an ulcer, an obstruction, or bleeding that has occurred in the inspection target and a sign of a disease that has occurred in a target to be inspected.

4. The learning device according to claim 1, wherein the hardware processor is configured to execute a software code to:
add auxiliary data indicating the certainty of the learning data to learning data indicating the presence of an abnormality; and
learn the discrimination dictionary by using the learning data including the auxiliary data.

5. The learning device according to claim 4, wherein the hardware processor is configured to execute a software code to set the certainty of the learning data lower as the learning data is based on an image captured earlier.

6. The learning device according to claim 4, wherein, in the case where the leaning data is inspected by using the discrimination dictionary and thereby it is determined that there is no abnormality in the leaning data, the hardware processor is configured to execute a software code to change the certainty of the learning data to a lower level.

7. The learning device according to claim 1, wherein, in the case where the leaning data is inspected by using the discrimination dictionary and thereby it is determined that there is no abnormality in the leaning data, the hardware processor is configured to execute a software code to change the learning data to leaning data indicating that there is no abnormality.

8. The learning device according to claim 1, the hardware processor is configured to execute a software code to align the first image to the second image, and generate learning data indicating that there is an abnormality in a region of the second image corresponding to the abnormal part in the first image.

9. The learning device according to claim 8, wherein the hardware processor is configured to execute a software code to generate learning data in which a label indicating an abnormality is added to pixels corresponding to the abnormal part or learning data in which a label indicating an abnormality is added to a region including the pixels corresponding to the abnormal part.

10. The learning device according to claim 1, wherein the hardware processor is configured to execute a software code to generate learning data indicating that an abnormal part is included from the second image in which it is uncertain whether or not the abnormal part is included on the basis of the first image of the inspection target including the abnormal part.

11. An inspection system comprising a hardware processor configured to execute a software code to:
acquire an image of an inspection target;
inspect the presence or absence of an abnormality in the inspection target from the acquired image by using a discrimination dictionary for discriminating the presence or absence of the abnormality in the inspection target, which has been learned by using learning data indicating that an abnormal part is included in a second image of the inspection target captured earlier than the time when a first image of the inspection target including an abnormal part is captured; and
output a result of the inspection by the inspection means.

12. A learning method comprising:
acquiring a first image of an inspection target including an abnormal part;
acquiring a second image of the inspection target captured earlier than the time when the first image is captured;
generating learning data indicating that the second image includes an abnormal part; and
learning a discrimination dictionary by using the generated learning data.

13-15. (canceled)
